(19) United States
(12) Patent Application Publication
(10) Pub. No.: US 2025/0237999 A1
(43) Pub. Date: Jul. 24, 2025

(54) DEVICE CASE AND TIMEPIECE

(71) Applicant: CASIO COMPUTER CO., LTD., Tokyo (JP)

(72) Inventor: Yoshiki NAKATSUKA, Tokyo (JP)

(21) Appl. No.: 19/033,734

(22) Filed: Jan. 22, 2025

(30) Foreign Application Priority Data
Jan. 23, 2024 (JP) 2024-008295

(51) Int. Cl. G04B 37/00

(52) U.S. Cl. CPC G04B 37/0008

(57) ABSTRACT

Provided is a device case including a case main body; a plurality of first exterior members arranged on a lateral part of the case main body; a plurality of second exterior members arranged on a lateral part of the case main body and fixed to the case main body; and a top face member that presses the plurality of first exterior members and the plurality of second exterior members from above. The top face member is fitted to the plurality of first exterior members. The case main body and each of the plurality of first exterior members are fixed to each other with a screw.

### REFERENCE TO RELATED APPLICATIONS

This application is based upon and claims the benefit of priority from the prior Japanese Patent Application No. 2024-008295, filed on Jan. 23, 2024, the entire contents of which are incorporated herein by reference.

### BACKGROUND OF THE INVENTION

### Field of the Invention

The present disclosure relates to a device case and a timepiece.

### Description of the Related Art

Japanese Patent Application Laid-Open No. 2001-033569 describes a timepiece incorporating an annular bezel and divided pieces fitted to the annular bezel (referred to as “chronograph watch” in JP2001033569A). In an example shown in JP2001033569A, divided pieces are fitted to the bezel at positions corresponding to four push buttons located at 2 o'clock, 4 o'clock, 8 o'clock, and 10 o'clock positions.

### SUMMARY

In order to solve the above-mentioned problem, the device case according to the present disclosure includes:
a case main body;
a plurality of first exterior members arranged on a lateral part of the case main body;
a plurality of second exterior members arranged on a lateral part of the case main body and fixed to the case main body; and
a top face member that presses the plurality of first exterior members and the plurality of second exterior members from above,
wherein the top face member is fitted to the plurality of first exterior members,
wherein the case main body and each of the plurality of first exterior members are fixed to each other with a screw.

### BRIEF DESCRIPTION OF THE DRAWING

FIG. 1 is a front view of an external appearance of a major part of a timepiece according to an embodiment.

FIG. 2 is a perspective view of the timepiece shown in FIG. 1.

FIG. 3 is an exploded perspective view of the major part of a device case according to the embodiment.

FIG. 4 is a perspective view of a case main body according to the embodiment.

FIG. 5 is a perspective view showing how buffer members and member locking pins are installed in the case main body.

FIG. 6 is a perspective view showing how first lateral face members are installed in the case main body with the buffer members and the member locking pins attached.

FIG. 7 is a perspective view showing how second lateral face members are installed in the case main body with the buffer members, the member locking pins, and the first lateral face members attached.

FIG. 8 is a cross-sectional view of the major part along a line VIII-VIII in FIG. 1.

FIG. 9 is a cross-sectional view of the major part along a line IX-IX in FIG. 1.

FIG. 10 is a cross-sectional view of the major part along a line X-X in FIG. 1.

FIG. 11 is a perspective view showing how a top face member is installed in the case main body.

FIG. 12 is a perspective view of the top face member as viewed obliquely from below.

FIG. 13 is a perspective view showing how a first exterior member is attached to the case main body on which the top face member is disposed.

FIG. 14 is a perspective view of the major part of the device case according to the embodiment as viewed from the back.

FIG. 15 is a cross-sectional view of the major part along a line XV-XV in FIG. 1.

### DETAILED DESCRIPTION OF THE PREFERRED EMBODIMENTS

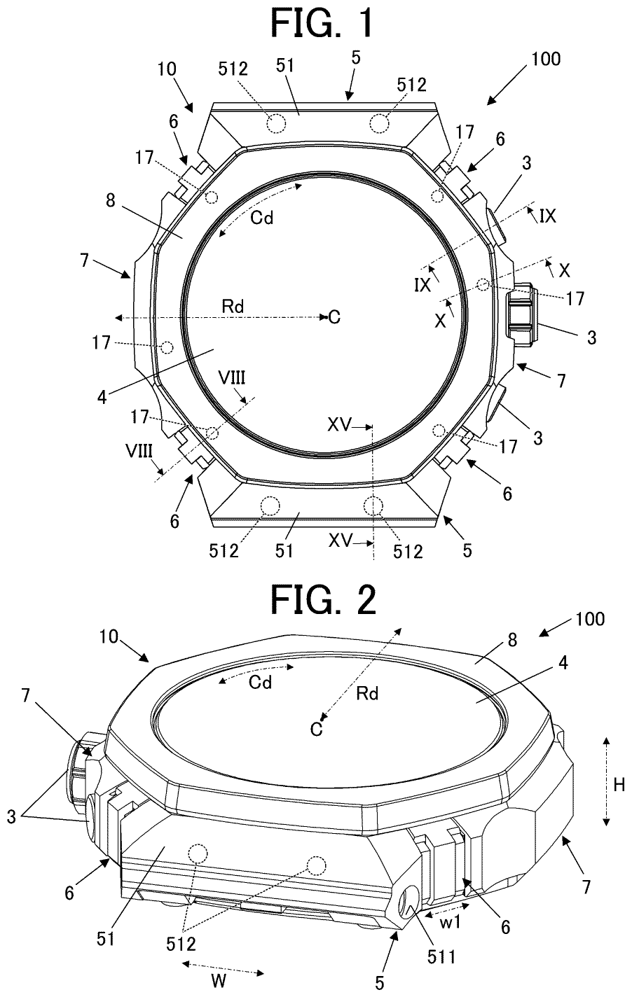

An embodiment of a device case and a timepiece equipped therewith will be described with reference to FIGS. 1 to 15. In this embodiment, the device case is a case of a timepiece (wristwatch). The embodiment described below is provided with various limitations technically preferable for carrying out the present invention. However, the scope of the present invention is not limited to the embodiment below or illustrated examples.

### Configuration

In the following embodiment, a “circumferential direction Cd” refers to a direction Cd shown in FIGS. 1 and 2, and a “radial direction Rd” refers to a direction Rd shown in FIG. 2.

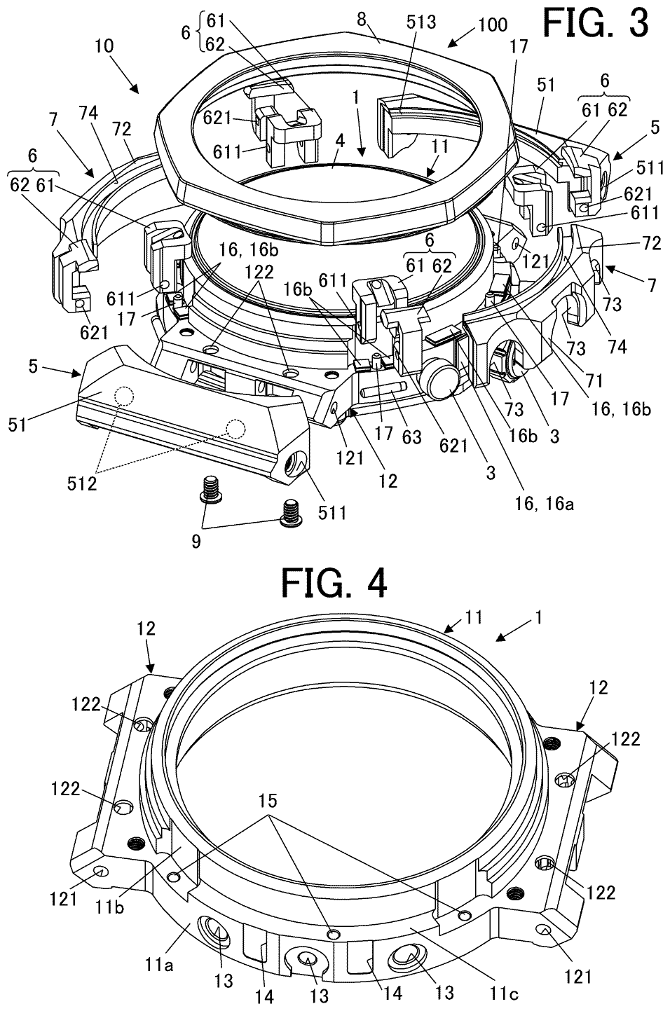

As shown in FIGS. 1 to 3, a timepiece 100 according to the present embodiment includes a device case 10. The device case 10 includes a case main body 1 (see FIG. 3), first exterior members 5, second exterior members, and a top face member 8. The second exterior members respectively include first lateral face members 7 and second lateral face members 7, as described later.

Japanese Patent Application Laid-Open No. 2001-033569 describes a timepiece incorporating an annular bezel and divided pieces fitted to the annular bezel (referred to as “chronograph watch” in JP2001033569A). In an example shown in JP2001033569A, divided pieces are fitted to the bezel at positions corresponding to four push buttons located at 2 o'clock, 4 o'clock, 8 o'clock, and 10 o'clock positions.

In the configuration described in JP2001033569A, each of the divided pieces is fixed by being screwed from the outside (see claim 1 of JP2001033569A). However, in a case where multiple members are attached to a device case or the like by being screwed, the number of screw parts increases and so does that of corresponding screw holes. These screw holes require space, increasing the size of the entire device.

The present disclosure has been conceived to improve and solve such a problem, and aims to provide a device case and a timepiece in which screwed points are reduced even with multiple members being attached to its exterior.

In the present embodiment, the case main body 1, the first exterior members 5, the second exterior members (the first lateral face members 6 and the second lateral face members 7), and the top face member 8 are made from metal materials such as titanium, stainless steel (SUS), and aluminum. The materials that form the case main body 1 and the like are not limited to these examples. In the present embodiment, the case main body 1, the first exterior members 5, the second exterior members (the first lateral face members 6 and the second lateral face members 7), and the top face member 8 may all be made from the same material or may be made from respectively different materials.

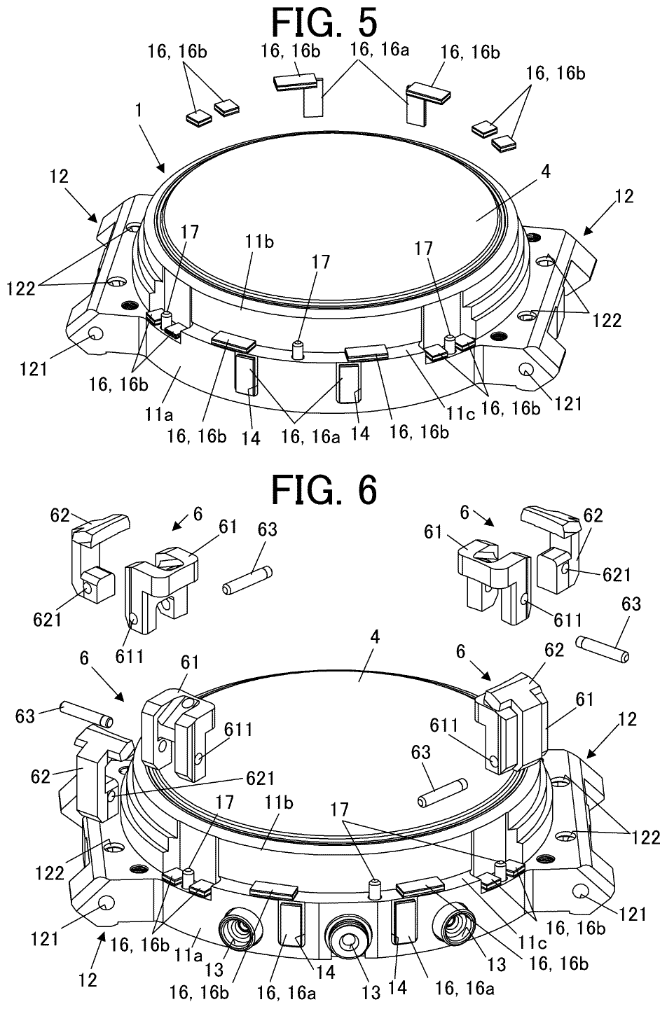

As shown in FIG. 4, the case main body 1 is formed in a substantially short cylinder shape. The case main body 1 in the present embodiment includes a hollow cylindrical section 11 which is open at the top and bottom in a thickness direction H of the timepiece 100 (see FIG. 2) and band attachment sections 12 to which a watch band (not shown) is attached.

Various components such as a module (not shown) are accommodated in the hollow part of the cylindrical section 11. The detailed configuration of the module is not described here, but the module includes, in a case where the timepiece 100 is a digital watch, a controller that controls various operating sections of the timepiece 100, a battery, and the like.

The timepiece 100 may include an analog display with hands (not shown), or may include a digital display section with a liquid crystal display or the like. In the case where the timepiece 100 is of an analog display type, the timepiece 100 includes a gear train (wheel train mechanism) and a driving section (motor or the like) as an operating section. In the case where the timepiece 100 is of a digital display type, the timepiece 100 includes a display section with a liquid crystal display screen or the like as an operating section instead of the above-described components, and the display section is disposed on the front side (viewing side) of the timepiece. The timepiece 100 may be of a hybrid type of digital and analog, and in that case, the timepiece 100 includes the components of both types as an operating section. The controller is mounted on a circuit board (not shown) and controls display operations by an operating section and the like.

The cylindrical section 11 includes a large diameter part 11a and a small diameter part 11b which has a smaller outer diameter than the large diameter part 11a does, and a step part 11c is formed at the boundary between the large diameter part 11a and the small diameter part 11b. Various operation units 3 (push buttons, crown, etc.) through which a user inputs various operations are provided on the exterior (the lateral part on the 3 o'clock side in the embodiment) of the device case 10, and through holes 13 through which axis parts (not shown) of the operation units 3 are inserted into the device case 10 are formed at the positions of the operation units 3 on the lateral part of the large diameter part 11a in an example shown in the drawings. The position, number, shape and the like of the operation units 3 are not limited to those shown in the drawings.

Recesses 14 to which buffer members 16 (see “buffer member 16a” shown in FIGS. 3 and 5) described later are attached are formed at the attachment positions of the second exterior members (the second lateral members 7 described later) on the lateral part of the large diameter parts 11a. Pin fixer holes 15 are formed on the step part 11c at the attachment positions of the second exterior members (the first lateral face members 6 and the second lateral face members 7). One end of each of the member locking pins 17 is press-fitted into each of the pin fixer holes 15. The member locking pins 17 are formed of a metal material such a stainless steel (SUS), for example. The buffer members 16 (see the “buffer members 16b” shown in FIGS. 3 and 5) are attached in the vicinity of the arrangement positions of the member locking pins 17 on the step part 11c.

FIG. 5 shows an example of arrangement of the buffer members 16 installed onto the case main body 1. In FIG. 5, one end of each of the member locking pins 17 is press-fitted to each of the pin fixer holes 15 of the case main body 1. The buffer members 16 (the buffer members 16a, 16b) are arranged in the vicinity of the recesses 14 formed on the large diameter part 11a, the member locking pins 17 and the like, as shown in FIG. 5. The buffer members 16 (the buffer members 16a, 16b) are formed of rubber (buffer rubber with cushioning properties), for example. The material of the buffer members 16 (buffer members 16a, 16b) is not limited to this. The material, thickness, and the like may be appropriately changed according to where they are provided.

The buffer members 16 (the buffer members 16a, 16b) have an adhesive surface at least on the side attached to the case main body 1, and are attached to the case main body 1. As described later, while the second exterior members (the first lateral face members 6 and the second lateral face members 7) are attached on the lateral part of the cylindrical section 11 of the case main body 1, the buffer members 16 are disposed between the case main body 1 and the second exterior members (the first lateral face members 6 and the second lateral face members 7) as being attached, by disposition of the buffer members 16 on the outer part of the main body 1 (the cylindrical section 11 of the case main body 1).

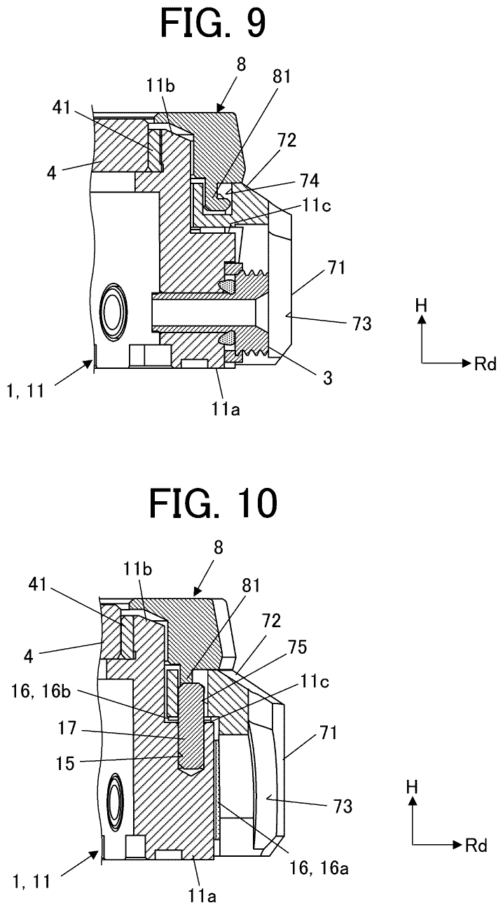

The band attachment sections 12 are provided respectively on the 12 o'clock side and the 6 o'clock side (i.e., both the upper and lower ends in FIG. 1) on the outer part of the cylindrical section 11 (the large diameter part 11a in the embodiment) of the case main body 1. Each of the band attachment sections 12 has a through hole 121 through which a spring pin or the like is inserted to attach a band along a width direction W (see FIG. 2) of the device case 10. The first exterior members 5 described later are respectively screwed onto the band attachment sections 12, and screw holes 122 are formed (see FIG. 4, etc.) at fixture positions of screws 9 (see FIG. 9). The first exterior members 5 are not necessarily screwed onto the band attachment sections 12, and they only need to be screwed onto the case main body 1 somewhere. In a case where the first exterior members 5 are screwed at positions not on the band attachment screw holes are formed at positions corresponding to the screws 9.

A back cover member (not shown) to cover the opening on the back side is provided on the lower side (the back face side of the timepiece 100) of the case main body 1. The case main body 1 and the back cover member may be integrally formed without an opening being formed on the lower side of the case main body 1. A windshield member 4 is attached to the open end on the upper side (viewing side of timepiece, surface side) of the case main body 1 via a waterproof ring 41 (see FIGS. 8 to 10). As the waterproof ring 41 or the like is interposed between the opening of the case main body 1 and the windshield member 4, the upper opening of the case main body 1 is closed with airtightness ensured. The windshield member 4 is a transparent member (cover member) formed of glass, transparent resin, or the like.

As shown in FIGS. 1 to 3, the first exterior members 5 are arranged so as to face each other across the case main body 1 (the cylindrical section 11 of the main body 1). In the embodiment, the first exterior members 5 are attached laterally to the band attachment sections 12 which are formed protruding on the 12 o'clock side and the 6 o'clock side of the case main body 1 (see FIG. 11) and are fastened to the band attachment sections 12 with the screws 9.

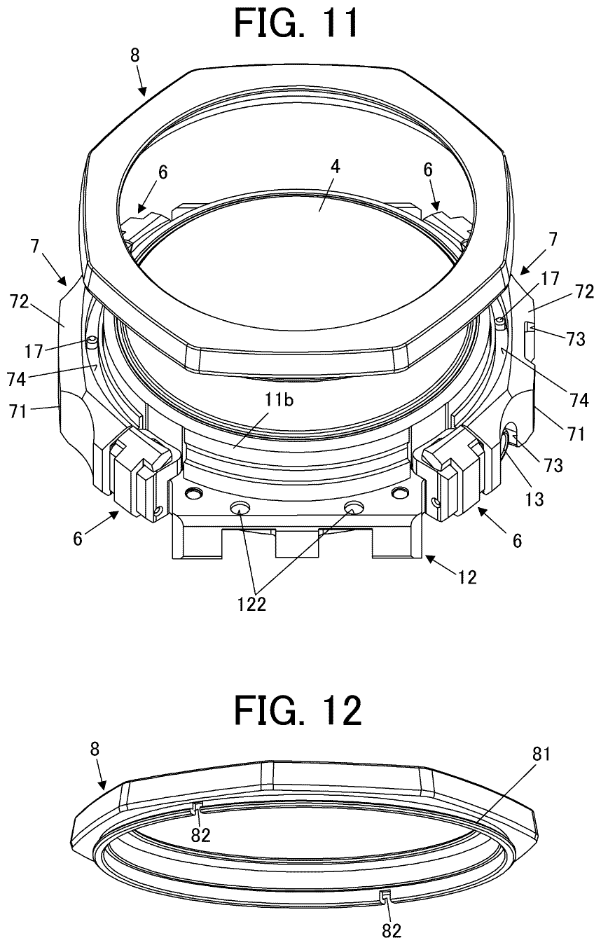

Part of each of the first exterior members 5 placed on the upper face of the corresponding band attachment section 12 is an eave-like section 51, and screw catches 512 are installed at positions of the screw holes 122 formed in the band attachment section 12 on the inside of the eave-like section 51. The screw catches 512 are formed from the back face side of the eave-like section 51, and preferably do not penetrate to the front face side in terms of external design. The positions of the screw catches 512 are indicated by dashed lines in FIGS. 1 to 3. The eave-like section 51 on the case main body 1 side is in an arc shape along the cylindrical shape of the cylindrical section 11 of the case main body 1. Along the arc-shaped edge of this arc part formed is a fitting groove 513 (see FIG. 3, etc.) to which a hooking part 81 (see FIG. 12, etc.) provided on the back face side of the top face member 8 described later is fitted.

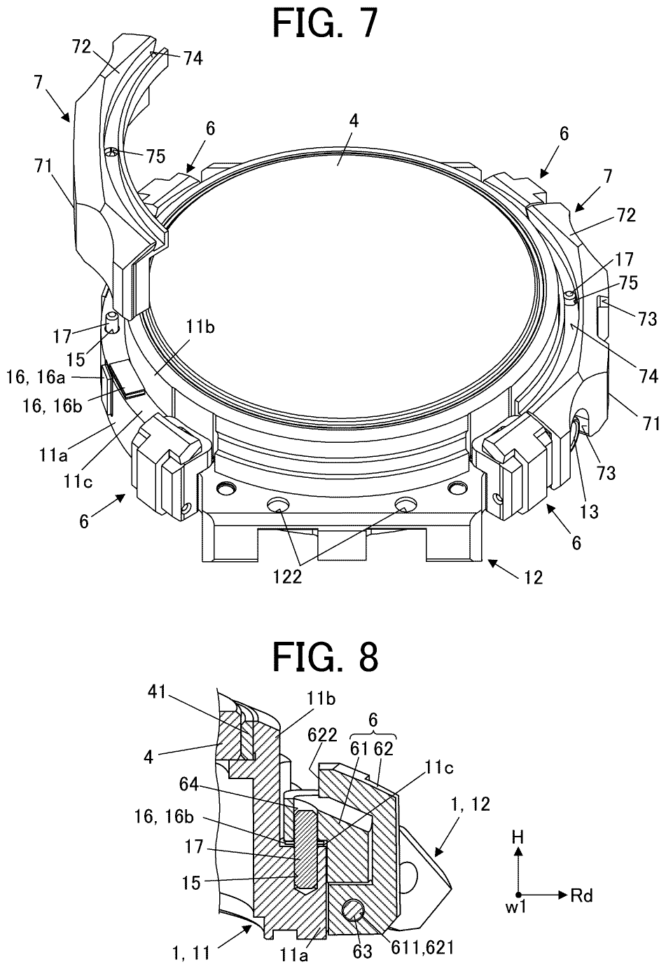

The second exterior members are arranged on the lateral side of the case main body 1 and fitted to the case main body 1 from above, and include the first lateral face members 6 arranged on the 2, 4, 8, and 10 o'clock sides and the second lateral face members 7 arranged on the 3 and 9 o' clock sides. FIG. 6 is a perspective view schematically showing how the first lateral face members are assembled and attached to the case main body, and FIG. 7 is a perspective view schematically showing how the second lateral face members are attached to the case main body. In FIG. 6, the buffer members 16 and the member locking pins 17 are already attached to the case main body 1, and in FIG. 7, the second lateral face members 7 are further attached to the case main body 1 to which the first lateral members 6 are already attached as in FIG. 6.

Each of the first lateral face members 6 in the embodiment is formed with a first part 61 in a frame shape and a second part 62 in a substantially T-shape being combined, and through holes 611 and 621 which penetrate through the first part 61 and the second part 62 in the combined state in a width direction w1 (see FIG. 2) of the corresponding first lateral face member 6 are formed at the corresponding positions of the first part 61 and the second part 62.

After the first part 61 and the second part 62 are combined so that the through holes 611 and 621 are in a through state, an axis member 63 is inserted through the through holes 611 ad 621 to integrate the first part 61 and the second part 62, thereby forming the first lateral member 6. The shapes of the first part 61 and the second part 62 that make up each of the first lateral face members 6 are not limited to those shown in the drawings. The first lateral face members 6 may have a variety of external designs by combining, for example, parts different from each other in color or surface texture as the first part 61 and the second part 62.

As shown in FIG. 8, at least part of the first lateral face members 6 is placed on the step part 11c of the case main body 1. A pin insertion hole 64 is formed in each of the first lateral face members 6 (as the second exterior members) on a side where the first lateral face members 6 are placed on the step part 11c. The pin insertion hole 64 may penetrate through both the first part 61 and the second part 62, or may be formed in one of them. In FIG. 8, the pin insertion hole 64 is formed in the first part 61. The pin insertion hole 64 may penetrate through the first lateral face member 6 or not. While each of the member locking pins 17 is press-fitted into the corresponding pin fixer hole 15 on one end, it is inserted into the corresponding pin insertion hole 64 on the other end. This allows the first lateral face members 6 to be positioned on the case main body 1, and locks the first lateral face members 6 not to move in a circumferential direction Cd.

In the present embodiment, the first part 61 is longer than the second part 62 in the radial direction Rd and the second part 62 is longer than the first part 61 in the thickness direction H in the state where each of the first lateral face members 6 is assembled. As a result, when the first lateral face member 6 is locked to the case main body 1 with the first part 61 being in touch with the external lateral face of the cylindrical section 11, a gap 622 is formed between the second part 62 and the external lateral face of the cylindrical section 11. As described later, at the time of assembly, the hooking part 81 provided in the top face material 8 is caught in the gap 622.

Each of the second lateral face members 7 includes a lateral face part 71 arranged on the lateral side of the large diameter part 11a of the cylindrical section 11 of the case main body 1, and an extended part 72 protruding from the lateral face part 71 toward a cylindrical center C of the cylindrical section 11 (see FIGS. 1 and 2). The lateral face part 71 and the extended part 72 on the case main body 1 side are in an arc shape along the cylindrical shape of the cylindrical section 11 of the case main body 1. The operation units 3 (push buttons, crown, etc.) are provided on the lateral part on the 3 o'clock side, and the through holes 13 are provided at positions corresponding to the operating units 3 on the large diameter part 11a, as described above in the present embodiment. Correspondingly, cutouts 73 are formed at positions of the operation units 3 and the through holes 13 in the lateral face part 71 of the one of the second lateral face members 7 placed on the 3 o'clock side.

A housing groove 74 is formed along the arc-shaped edge on the upper face of the extended part 72.

The extended part 72 in which the housing groove 74 is placed on the step part 11c in the state where it is assembled to the case main body 1. As shown in FIG. 9, the hooking part 81 of the top face member 8 described later is housed in the housing groove 74.

Pin insertion holes 75 are formed at positions of the member locking pins 17 in the second lateral face members 7 (as the second exterior members) placed on the step part 11c. As shown in FIG. 7, etc., the pin insertion holes 75 are provided inside the housing groove 74. While each of the member locking pins 17 is press-fitted into the corresponding pin fixer hole 15 on one end, it is inserted into the corresponding pin insertion hole 75 on the other end. This allows the second lateral face members 7 to be positioned on the case main body 1, and locks the first lateral face members 6 not to move in a circumferential direction Cd. The second lateral face members 7 may slightly cover the adjacent ones of the first lateral face members 6 with the both ends (of the second lateral face members 7) being formed obliquely in the circumferential direction Cd. This is preferable because a gap is not likely to be formed between the second exterior members and the appearance becomes excellent.

As shown in FIG. 10, the pin insertion holes 75 are through holes and the other ends of the member locking pins 17 respectively penetrate through the second lateral face members 7 (as the second external members) to protrude upward from the pin insertion holes 75. Cutouts that catch the member locking pins 17 are provided at the positions where the member locking pins 17 protrude on the lower face side of the top face member 8. In the present embodiment, as described above, cutouts 82 (see FIG. 12) are formed at the hooking part 81 formed on the lower face side of the top face member 8 at the positions where the member locking pins 17 protrude. This allows the hooking part 81 to be housed in the housing groove 74 without hitting the corresponding member locking pin 17. As the penetrating parts of the member locking pins 17 are caught in the cutouts 82, the upper face member 8 is positioned and prevented from rotating freely in the circumferential direction Cd.

As shown in FIG. 10, the pin insertion holes 75 formed at the extended parts 72 are long holes elongated in the radial direction Rd of the case main body 1 (the cylindrical section 11 of the case main body 1) than the diameter of the member locking pins 17. That is, the member locking pins 17 inserted into the pin insertion holes 75 are respectively in contact with the walls of the pin insertion holes 75 on the case main body 1 side, but are not in contact with the walls on the outer side, making a certain amount of backlash. How long the pin insertion holes 75 are and how much backlash is provided are appropriately determined. For example, when a deep impact is given on the 3 o'clock side or the 9 o'clock side due to a fall or the like, the second lateral face members 7 can move toward the case main body 1 to the extent of the backlash, and the second lateral face members 7 can shift toward the case main body 1 side while crushing the buffer members 16 (the buffer members 16a) provided between the large diameter part 11a of the case main body 1 and the second lateral face members 7 (as the second exterior members).

As shown in FIG. 11, etc., the top face member 8 is formed in a substantially ring shape, and is arranged so as to press from above the first exterior members 5 and the first lateral face members 6 and the second lateral face members 7 (as the second exterior members). As shown in FIG. 12, the top face member 8 includes the hooking part 81 in a substantially L-shape (see FIG. 9, etc.) in a cross-sectional view on the lower face side. The hooking part 81 is preferably provided along the entire circumference in the circumferential direction Cd of the top face member 8.

When the top face member 8 is placed onto the case main body 1 from above the first lateral members 6, the second lateral members 7, and the like, the hooking part 81 is housed in the gap 622 of each of the first lateral face members 6 and the housing groove 74 of each of the second lateral face members 7. As a result, even the hooking part 81 formed along the entire circumference of the top face member 8 can be placed above the first exterior members 5, the first lateral face members 6, and the second lateral face members 7 without interfering them. The gap 622 of each of the first lateral face members 6 and the housing groove 74 of each of the second lateral face members 7 are arranged without a gap in between, and as the hooking part 81 is housed therein, the displacement of the first lateral face member 6 and the second lateral face member 7 can be prevented and the first lateral face members 6 and the second lateral face members 7 are pressed almost evenly along the entire circumference from above.

As shown in FIG. 13, in the present embodiment, after the first exterior members 5, the second exterior members (the first lateral members 6 and the second lateral members 7), and the top face member 8 are attached to the case main body 1, the first exterior members 5 are attached from the sides of the case main body 1.

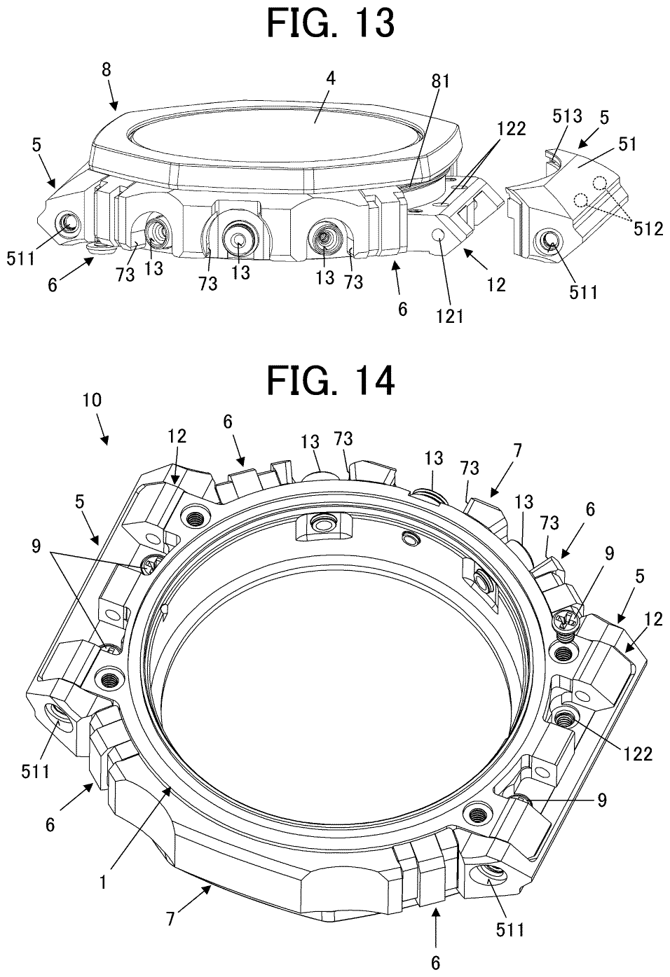

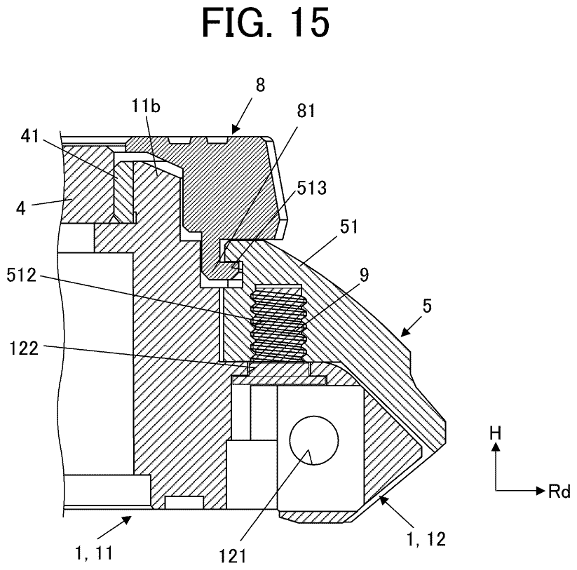

At this time, the L-shaped hooking part 81 of the top face member 8 is hooked to the fitting grooves 513 formed in the first exterior members 5, and the top face member 8 is fitted to the first exterior members 5. As shown in FIGS. 14 and 15, the case main body 1 and the first exterior member 5 are fixed by being screwed with the screws 9 from the back face side of the device case 10.

### Functions

Next, the functions of the device case 10 and the timepiece 100 equipped therewith according to the present embodiment will be described.

In manufacturing the device case 10 and the timepiece 100 equipped therewith, the module is housed in the case main body 1 and the opening on the viewing side is closed with the windshield member 4 while the opposite opening on the non-viewing side is closed with the back cover member.

Then, as shown in FIG. 5, for example, the buffer members 16 (the buffer members 16a) are attached to the recesses 14 provided in the large diameter part 11a of the cylindrical section 11 of the case main body 1. One end of each of the member locking pins 17 is press-fitted into each of the pin fixer holes 15 formed in the step part 11c. Further, the buffer members 16 (the buffer members 16b) are attached onto the step part 11c on the both sides of the member locking pins 17 on the 2, 4, 8, and 10 o'clock sides and in the vicinity of the member locking pins 17 on the 3 and 9 o'clock sides.

Next, as shown in FIG. 6, the first parts 61 and the second parts 62 are respectively fitted together, and the axes 63 are inserted to the through holes 611 and 621 which are penetrate through each other to integrate them, thereby forming the first lateral side faces 6. The first lateral face members 6 are attached to the case main body 1 from above so that the other end of each of the member locking pins 17 on the 2, 4, 8, and 10 o'clock sides is inserted to each of the pin insertion holes 64 of the first lateral face members 6.

Then, as shown in FIG. 7, the second lateral face members 7 are attached to the case main body 1 so that the other end of each of the member locking pins 17 on the 3 and 9 o'clock sides is inserted into each of the pin insertion holes 75 of the second lateral members 7. Further, as shown in FIG. 11, the top face member 8 is disposed from above so as to press the first lateral face members 6 and the second lateral face members 7 as the second exterior members. At this time, the hooking part 81 on the lower face of the top face member 8 is housed in the gap 622 (see FIG. 8) of each the first lateral face members 6 and the housing groove 74 (see FIG. 9) of the second lateral face members 7 between the first lateral face members 6 and the case main body 1. The position of the top face member 8 in the circumferential direction Cd is adjusted so that the two cutouts 82 in the hooking part 81 (see FIG. 12) correspond to the member locking pins 17 protruding from the pin insertion holes 75 (see FIG. 9).

This allows the first lateral face members 6 and the second lateral face members 7 as the second exterior members to be locked by the member locking pins 17, preventing displacement of the case main body 1 toward the outer periphery or in the circumferential direction Cd, and also allows them to be pressed by the top face member 8 from above, preventing displacement in the upward direction.

As the tip of each of the member locking pins 17 which lock the second lateral face members 7 is fitted to the corresponding cutout 82 of the hooking part 81, the top face member 8 can be correctly positioned, regulating rotation of the upper face member 8 in the circumferential direction Cd. Thus, in a case a logo or the like is provided on the top face member 8, for example, it can be prevented from being shifted.

Finally, as shown in FIG. 13, the first exterior members 5 are attached to the case main body 1 laterally so that they cover the band attachment sections 12 on the 6 o'clock side and the 12 o'clock side. At this time, as the hooking part 81 of the top face member 8 is hooked to the fitting grooves 513 of the first exterior members 5, the first exterior members 5 and the top face member 8 are fitted together, preventing the top face member 8 from coming off in the upward direction. As shown in FIG. 14, the screws 9 are inserted to the screw holes 122 from the back face side of the device case 10 so that the case main body 1 and the first exterior members 5 are screwed to be fixed in this state.

The first exterior members 5 are pulled toward the case main body 1 side (i. e., the lower side in the thickness direction H) by the screws 9 inserted from the back side of the case main body 1, as shown in FIG. 15, and the top face member 8 the hooking part 81 of which is hooked to the fitting grooves 513 of the exterior members 5 is also pulled in the downward direction, further preventing the top face member 8 from coming off in the upward direction. As a result, the multiple exterior members provided separately (i.e., the first exterior members, the second exterior members (the first lateral face members 6 and the second lateral face members 7), and the top face member) can be securely fixed to the case main body 1 as the screws 9 are used only at the fixing points between the case main body 1 and the first exterior members 5.

### Advantageous Effects

As described hereinbefore, in the present embodiment, the device case 10 includes the case main body 1, the first exterior members 5, the second exterior members (the first lateral face members 6 and the second lateral face members 7), and the top face member 8. The second exterior members (the first lateral face members 6 and the second lateral face members 7) are fitted to the case main body 1 from above and pressed by the top face member 8 from above, thereby preventing the second lateral members (the first lateral face members 6 and the second lateral members 7) from coming off in the upward direction. The first exterior members 5 which are fitted to the top face member 8 are fastened to the case main body 1 by the screws 9.

As a result, the exterior members (the first exterior members 5 and the second exterior members (the first lateral face members 6 and the second lateral members 7)) arranged on the lateral part of the case main body 1 and the top face member 8 are all fixed to the case main body 1 only by the screws 9 that fasten the first exterior members 5 to the case main body 1. Thus, the number of screw parts can be suppressed, which also reduces screw holes and space for screws, and the device case 10 can be more compact.

The first exterior members 5 according to the present embodiment face one another with the case main body 1 in between. Specifically, the first exterior members 5 are arranged corresponding to the band attachment sections 12 on the 6 and 12 o'clock sides. As the first exterior members 5, which are fixed by the screws 9 in the embodiment, face one another with the case main body 1 in between, each of the exterior members (the first exterior members 5 and the second exterior members (the first lateral face members 6 and the second lateral members 7)) and the top face member 8 can be fixed to the case main body 1 using a small number of the screws 9 in a well-balanced and secure manner.

The case main body 1 in the present embodiment includes pins (the member locking pins 17) which are press-fitted into the second exterior members (the first lateral side members 6 and the second lateral face members 7) on one end, and the second exterior members (the first lateral face members 6 and the second lateral face members 7) include the pin insertion holes 64 and 75, into which the member locking pins 17 are inserted on the other end. As a result, the second exterior members (the first lateral face members 6 and the second lateral face members 7) are temporarily fixed before they are eventually fastened with the screws 9, which can prevent displacement in the assembly and facilitate the assembly.

The top face member 8 in the present embodiment has the hooking part 81 in an L-shape on the lower side, and the top face member 8 can be fitted to the exterior members 5 with the hooking part 81 being hooked to the grooves (the fitting grooves 513) formed on the first exterior members 5. As a result, the top face member 8 can be easily temporarily fixed not to come off in the upward direction just with the hooking part 81 being hooked to the fitting grooves 513.

In the present embodiment, the buffer members 16 (16a, 16b) are provided between the case main body 1 and the second exterior members (the first lateral face members 6 and the second lateral face members 7). As a result, in a case where the case main body 1 and the second exterior members (the first lateral face members 6 and the second lateral face members 7) are made from metal materials, these metal parts do not hit each other and damage or breakage can be prevented. Also, the impact resistance of the device case 10 as a whole can be improved.

Among the pins (the member locking pins 17) in the present embodiment, those corresponding to the second lateral face members 7 as the second exterior members protrude upward through the second lateral face members 7, and the cutouts 82 which catch the protruding parts of the member locking pins 17 are provided on the lower side of the top face member 8 at the positions where the member locking pins 17 protrude. Thus, when the top face member 8 is attached from above the second exterior members (the second lateral face members 7), the top face member 8 can be easily positioned in the circumferential direction Cd as the protruding parts are aligned with the cutouts 82 of the member locking pins 17. Rotation in the top face member 8 in the circumferential direction Cd can also be regulated.

The pin insertion holes 75 in the present embodiment are long holes elongated in the radial direction Rd of the case main body 1. The buffer members 16a are provided between the second exterior members (the second lateral face members 7) and the case main body 1, and with backlash being provided in the pin insertion holes 75 in the radial direction Rd, the exterior members (the second lateral face members 7) can shift toward the case main body 1 side while crushing the buffer members 16a when an impact is given in the radial direction Rd. This can absorb the impact effectively, preventing damage in the device case 10 and the module and the like housed therein.

The timepiece in the present embodiment includes the device case described here. As a result, in the case where the exterior members (the first exterior members 5, the second exterior members (the first lateral face members 6 and the second lateral face members 7), and the top face member 8) provided separately are attached to the case main body 1, the screw points can be reduced and each of the exterior members does not easily come off the case main body 1. Thus, the timepiece 100 with excellent design can be realized with a small number of screw parts. The space for screw holes can be also reduced, and thereby the device case 10 and the timepiece 100 equipped therewith can be more compact.

### Modification

Although an embodiment of the present disclosure is described above, needless to say, the present disclosure is not limited to the embodiment and can be appropriately modified in a variety of aspects without departing from the scope of the present disclosure.

For example, in the above embodiment, the members exteriorly provided to the case main body 1 are the first exterior members 5 on the 6 and 12 o'clock sides, the first lateral members 6 on the 2, 4, 8, and 10 o'clock sides, the second lateral members 7 on the 3 and 9 o'clock sides (the second exterior members), and the top face member 8, for example, but the members exteriorly provided to the case main body 1 are not limited to those. For example, in place of the second lateral face members 7 on the 3 and 9 o'clock sides, small members equal to the first lateral face members 6 may be provided, that is, the second exterior members may be more separately provided.

For example, only the member locking pins 17 which lock the second lateral face members 7 protrude and the two cutouts 82 to catch them are provided in the top face member 8, but the member locking pins 17 protruding toward the top face member 8 side are not limited to those. The member locking pins 17 protruding to the top face member 8 side may be the member locking pins 17 that lock the first lateral face members 6, for example, and the member locking pins 17 that lock the first lateral face members 6 and the member locking pins 17 that lock the second latera face members 7 may all protrude to the top face member 8 side. In that case, the cutouts 82 corresponding to all the protruding member locking pins 17 are provided in the top face member 8.

Further, for example, the first lateral face members 6 are each made of the first part 61 and the second part 62, but the first lateral face members 6 may be each made of one member. In that case, the number of components can be reduced and the work of assembling and integrating the first part 61 and the second part 62 can be omitted. On the other hand, the second lateral face members 7 may be made of multiple components assembled and integrated. A more complex appearance can be achieved in that case.

For example, the first exterior members and the second exterior members may be made from metal materials other than titanium, stainless steel (SUS), aluminum, or may be made from a material other than metal such as glass and ceramic, for example. The first exterior members and the second exterior members may be all made from the same materials or may be a combination of different kinds of materials.

Further, for example, the first exterior members 5 that respectively include the fitting grooves 513 hooking the hooking part 81 of the top face member 8 and that are fastened by the screws 9 are arranged on the 6 and 12 o'clock sides, but the first exterior members 5 are not limited to those. The first exterior members 5 just need to be fitted to the top face member 8 to prevent the top face member 8 from coming off in the upward direction, and may be a member arranged at a position other than on the 6 and 12 o'clock sides. As the members fitted to the top face member 8 are screwed with the case main body 1 by the screws 9, the top face member 8 and each member pressed by the top face member 8 from above can be fixed to the case main body 1.

In the embodiment, each of the first exterior members 5 is screwed with the two screws 9, which make the first exterior members 5 are screwed by the four screws 9 on the 6 and 12 o'clock sides in all, for example, but the number of screws for fixture is not limited to four. Each of the first exterior members 5 on the 6 and 12 o'clock sides may be fixed by one screw 9, for example. In that case, the first exterior members 5 on the 6 and 12 o'clock sides can be fixed by two screws 9 in all, and the numbers of screw parts and screw points can be further reduced.

The top face member 8 just needs to be fitted to the first exterior members 5, and it is not limited to the one in the embodiment that has the hooking part 81. The hooking part 81 is not limited to the one that is provided along the entire circumference of the top face member 8, and a hooking part just needs to be provided at positions where to be fitted to the first exterior members 5 screwed thereto, at least. In that case, the second exterior members (the first lateral face members 6 and the second lateral face members 7) may not be provided with the gap 622 or the housing groove 74.

In addition, in the embodiment, only the pin insertion holes 75 in the second lateral face members 7 are long holes elongated in the radial direction of the case main body 1, but only part of the pin insertion holes needs to be elongated in the radial direction of the case main body 1, at least. Such long holes are not limited to the pin insertion holes 75.

For example, the pin insertion holes 64 in the first lateral face members 6 may be long holes elongated in the radial direction of the case main body 1. The pin insertion holes 75 and the pin insertion holes 64 may be all long holes elongated in the radial direction of the case main body 1. In a case where the pin insertion holes 75 and the pin insertion holes 64 are all long holes, the second exterior members (the first lateral face members 6 and the second lateral members 7) can be shifted in response to an impact in various directions, which is expected to improve impact resistance. In a case where the pin insertion holes 64 are long holes, there are preferably buffer members 16 between the first lateral face members 6 and the small diameter part 11b.

In the embodiment, the second exterior members (the first lateral face members 6 and the second lateral members 7) are fixed to the case main body 1 with the member locking pins 17, but the configuration is not limited to this. Double-sided tapes may be disposed instead of the buffer members 16, and the second exterior members (the first lateral face members 6 and the second lateral face members 7) may be fixed to the case main body 1 with the double-sided tapes.

Furthermore, the device case 10 is applied to the timepiece 100 in the embodiment, for example, but the device case 10 is not always a case for a timepiece. The device case 10 according to the embodiment may be applied to any case that houses inside the case main body 1 components susceptible to damage due to an impact. For example, the device case 10 can be applied to an electronic device such as a smart watch and sports watch, a wearable device that acquires biological information such as heartbeat and blood flow in addition to giving time information.

In the above, one or more embodiments of the present disclosure are described. However, the scope of the present disclosure is not limited thereto, and includes the scope of claims below and the scope of their equivalents.

1. A device case comprising:
a case main body;
a plurality of first exterior members arranged on a lateral part of the case main body;
a plurality of second exterior members arranged on a lateral part of the case main body and fixed to the case main body; and
a top face member that presses the plurality of first exterior members and the plurality of second exterior members from above,
wherein the top face member is fitted to the plurality of first exterior members,
wherein the case main body and each of the plurality of first exterior members are fixed to each other with a screw.

2. The device case according to claim 1,
wherein the plurality of second exterior members are fitted to the case main body from above.

3. The device case according to claim 1,
wherein the plurality of first exterior members are arranged at positions facing each other across the case main body.

4. The device case according to claim 1,
wherein the case main body is provided with a pin having one end press-fitted at a position corresponding to each of the plurality of second exterior members.

5. The device case according to claim 4,
wherein a pin insertion hole is formed in each of the plurality of second exterior members.

6. The device case according to claim 5,
wherein the pin is inserted into the pin insertion hole on an end other than the one end.

7. The device case according to claim 1,
wherein the top face member includes an L-shaped hooking part on a lower side.

8. The device case according to claim 7,
wherein a groove is formed in each of the plurality of first exterior members.

9. The device case according to claim 8,
wherein the top face member is fitted to each of the plurality of first exterior members with the hooking part being hooked into the groove.

10. The device case according to claim 1,
wherein a buffer member is provided between the case main body and each of the plurality of second exterior members.

11. The device case according to claim 6,
wherein at least part of the pin protrudes upward through the plurality of second members.

12. The device case according to claim 11,
wherein a cutout that catches a protruding part of the pin is provided in the top face member on a lower side.

13. The device case according to claim 6,
wherein at least part of the pin insertion hole is a long hole that is elongated in a diameter direction of the case main body.

14. A timepiece comprising:
the device case according to claim 1,

15. A timepiece comprising:
the device case according to claim 2.

16. A timepiece comprising:
the device case according to claim 3.
